(19) United States
(12) Patent Application Publication
(10) Pub. No.: US 2021/0110586 A1
(43) Pub. Date: Apr. 15, 2021

(54) MIXED RASTER CONTENT (MRC) TO CONTROL COLOR CHANGES

(71) Applicant: XEROX CORPORATION, Norwalk, CT (US)

(72) Inventors: Sainarayanan Gopalakrishnan, Chennai (IN); Rajasekar Kanagasabai, Chennai (IN)

(73) Assignee: XEROX CORPORATION, Norwalk, CT (US)

(21) Appl. No.: 16/599,147

(22) Filed: Oct. 11, 2019

(51) Int. Cl. G06T 11/60; H04N 1/64; G06T 7/90; G06K 9/00; H04N 1/41

(52) U.S. Cl. CPC G06T 11/60; H04N 1/642; H04N 1/41; G06K 9/00456; G06T 7/90

(57) ABSTRACT

Methods and systems for generating a mixed raster content (MRC) format file are disclosed. The method includes receiving an input document. The input document is segmented into an image layer and a text layer with a color mask information. A determination is made whether a text group in the text layer has a color different than the color mask information. Upon an affirmative determination, an ascertainment is made whether the color mask is above a threshold value. An average of the color mask is calculated and based on the calculation, a new color is applied to the text group to modify the text layer. Then, the modified text layer is compressed using a first compression scheme, the image layer is compressed using a second compression scheme, the compressed the modified text layer and the image layer are integrated to generate an image data in an MRC file format.

### TECHNICAL FIELD

The present subject matter relates generally to mixed raster content (MRC) imaging systems and more particularly to a method and a system for generating an MRC file format.

### BACKGROUND

In printing technology, scanning, exporting, and storing of color images in a printing network have started to become the standard features offered by digital multifunction devices. For such standard features, the file size of an image document is an important factor. The file size of the image document that needs to be exported or stored is nowadays optimized using different available compression schemes and/or file formats. One of the popular compression schemes/file formats that are currently being offered is Mixed or Multiple Raster Content (MRC) file formats. The MRC file format provides a way to achieve high image quality with small file size.

The MRC file format is generated by segmenting the image document (such as image file comprising mixed content such as text and pictorial/image data) into two or more layers including, for example, image layer (background layer) and text layer (foreground layer). Segmentation of the image document into the layers tends to improve compression of the image document, and also allows different compression methods to be applied to the different layers. For example, it is generally known in the art that the MRC compression scheme implements JPEG compression to the image layer and JBIG2 compression to the text layer, in order to manipulate and compress the image document.

However, when low compression or low dots per inch (DPI) resolution is selected as compression scheme during scanning, images produced by digital devices tend to produce artifacts that are visible while regeneration of the text layer (foreground layer). Also, sometimes, the color of the reproduced text may not match to the color of the original text. For example, in a single word, one alphabet/character may have changed purple color while the remaining alphabets/characters of the word have original violet color.

Accordingly, there is a need for a method and a system for generating an MRC file format that can avoid color variation of text while reproducing the image.

### SUMMARY

In one implementation, a method for generating a mixed raster content (MRC) format file is disclosed. The method includes receiving an input document at an image capturing device. Upon receipt of the input document, the input document is segmented into an image layer and a text layer with a color mask information. Then, a determination is made as to whether a text group in the text layer has a color different than the color mask information. Upon an affirmative determination, an ascertainment is made whether the color mask is above a threshold value. Upon affirmative ascertainment, an average of the color mask is calculated and based on the calculation, a new color is applied to the text group so as to modify the text layer. Then, the modified text layer is compressed using a first compression scheme, the image layer is compressed using a second compression scheme, the compressed the modified text layer and the image layer are compressed to generate an image data in the MRC file format, and the generated image data is stored in a memory device.

In another implementation, an image processing system implementing the subject matter includes a processor, an image capturing device, a segmentation module, and a compression module. The input device is provided to receive an input document. The received input document is then segmented by the segmentation module into an image layer and a text layer with a color mask information. Thereafter, the compression module determines whether a text group in the text layer has color different than the color mask information; upon affirmative determination, ascertains whether the color mask is above a threshold value; upon affirmative ascertainment, calculates an average of the color mask; applies a new color to the text group based on the calculated average of the color mask, so as to modify the text layer; compresses the modified text layer using a first compression scheme; compresses the image layer using a second compression scheme; integrates the compressed the modified text layer and the image layer to generate an image data in the MRC file format; and stores the generated image data in a memory device.

In yet another implementation, a non-transitory computer-readable medium implementing the subject matter includes instructions executable by a processing resource. The instructions are executed to receive an input document at an image capturing device. Upon receipt of the input document, the input document is segmented into an image layer and a text layer with a color mask information. Then, a determination is made as to whether a text group in the text layer has a color different than the color mask information. Upon an affirmative determination, an ascertainment is made whether the color mask is above a threshold value. Upon affirmative ascertainment, an average of the color mask is calculated and based on the calculation, a new color is applied to the text group so as to modify the text layer. Then, the modified text layer is compressed using a first compression scheme, the image layer is compressed using a second compression scheme, the compressed the modified text layer and the image layer are compressed to generate an image data in the MRC file format, and the generated image data is stored in a memory device.

Other and further aspects and features of the present subject matter will be evident from the following detailed description of the exemplary implementations, which are intended to illustrate, not limit, the present subject matter.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein.

FIG. 1 illustrates an image processing system as per implementation of the present subject matter.

FIG. 2 illustrates the image processing system in detail as per the implementation of the present subject matter.

FIG. 3 illustrates an MRC compression scheme according to an implementation of the present subject matter.

FIGS. 4A-4D represent output of conventional approach; while FIGS. 5A-5D show output of exemplary implementations of the present subject matter.

FIG. 6 illustrates a networking environment for the image processing system in accordance with the present subject matter.

FIGS. 7A-7B illustrate a method of implementing the various processes of the image processing system.

### DESCRIPTION

A few aspects of the present subject matter are explained in detail below with reference to the various figures. Example implementations are described to illustrate the disclosed subject matter, not to limit its scope, which is defined by the claims. Those of ordinary skill in the art will recognize a number of equivalent variations of the various features provided in the description that follows.

### Non-Limiting Definitions

In the disclosure hereinafter, one or more terms are used to describe various aspects of the present subject matter. For a better understanding of the subject matter, a few definitions are provided herein for better understating of the present disclosure.

“Image data” refers to a pattern of physical light captured or generated at a user device including workstations, personal computers, personal digital assistants (PDAs), laptop computers, notebooks, smartphones, and the like. The image data may include fill objects such as characters, words, text, and other objects such as graphics, photos, etc. The image data may be included in a set of one or more input images, such as in input images of the pages of a document. The input image may be divided into segments, objects, or structures, each of which is itself an image. A segment, object, or structure of the input image may be of any size up to and including the whole input image.

“Image capturing device” may be an input device. The image capturing device may be any type of device for receiving the image data. Examples of the image capturing device may include, but not limited to, a scanning device, a facsimile device, a computing device, a storage device, and the like.

“Processor” may be a single dedicated processor, a single shared processor, or a plurality of individual processors, some of which may be shared. Moreover, explicit use of the term “processor” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), non-volatile storage. Other hardware, conventional and/or custom, may also be included.

“Mixed or Multiple Raster Content (MRC) file format” is a format storing compressed images into at least two components, namely text layer component and an image layer component. By storing the images into two different components, the most efficient and accurate compression algorithms can be used for each type of the components.

“Image layer” is one of the layer component stored in the MRC file format. Image layer may be used for storing continuous-tone (i.e., contone) information, such as background attributes of an image, like pictures and/or smoothly varying background colors.

“Text layer” is one of the layer component stored in the MRC file format. Text layer may hold the color information corresponding to the corresponding text and/or line art found in the text layer.

The term “average” refers to calculation of average/mean RGB colors in a text layer/group. The term “maximum” refers to maximum of RGB color repetitions. The term “threshold value” is an integer value to take a decision/conclusion. The term “Color Mask Information” is where each text layer has the RGB color information, referred to as color mask.

“Printer” may be defined as including, but not necessarily limited to, a peripheral that produces a representation of a document on one or both sides of media such as paper, plastic sheet, fabric, etc. A printer can be a single function device or multi-function (e.g., including scanning, faxing, or other functionality) device. The printer may include software, hardware, firmware, or combination thereof. Further, the printer can use any of a variety of different types of marking technologies such as a laser, inkjet, dye-sublimation, off-set printing, thermal printing, impact printing, etc. As used herein, the terms “render” and “rendering” are defined as including, but not necessarily limited to, taking print data such as text, images, graphics, etc. and converting them into a ready to print (RTP) format that is compatible with a destination printer.

“Image scanner” often abbreviated to just scanner. Although the term is ambiguous out of context (barcode scanner, CAT scanner, etc.), the image scanner is a device that optically scans images, printed text, handwriting or an object and converts it to a digital image.

“Image reader” is a computer program that can display stored graphical images. The image reader can often handle various graphics file formats. Such computer program or reader usually renders the image according to properties of the display such as color depth, display resolution, and color profile.

“Document generator” is a programming tool that generates software documentation intended for programmers (API documentation) or end users, or both, from a set of especially commented source code files, and in some cases, binary files.

“Computer-readable medium” or “storage medium” may be a physical medium that can store data. Examples of “computer-readable medium” may include a magnetic medium such as diskettes, floppy disks, and tape; an optical medium such as laser disks and CD-ROMs; and semiconductor media such as semiconductor ROMs and RAMs. As used herein, “storage medium” covers one or more distinct units of a medium that together store a body of data. For example, a set of floppy disks storing a single body of data may together be storage medium.

### Overview

Various exemplary implementations of a method and a system according to this disclosure process an image data of a document to produce highly-compressed image data files that accurately capture the original document content and provide optimal file size and image quality balance for processing and output of the image data. File size and quality are some factors that users face when compressing and exporting color images using digital multifunction devices and printers. Apart from offering different resolutions, different compression schemes are being offered in these devices as well.

Various method(s) and system(s) of the present subject matter described herein allow generation of a Mixed or Multiple Raster Content (MRC) file format. The method begins with receipt of an input document having image data including a plurality of pixels. The image data may be received as the input document by, for example, an image capturing device, or retrieved from storage or memory. In an example, the image capturing device may be an input device. The image capturing device may be any type of device for receiving input image data. Example of the image capturing device may include, but not limited to, a scanning device, a facsimile device, a computing device, a storage device, and the like.

Once the input document is received, the input document is processed to determine the different types of data represented by the plurality of pixels of the image data using existing segmentation techniques. For example, the image data may include pixels representing, but not limited to, text, edge, background, and pictorial (non-text area) information. As per the present subject matter, any number of segmentation methods or techniques may be used for the determination of the types of data represented by the plurality of the pixels of the image data. Then, based on the determined types of data represented by the plurality of pixels, the segmentation methods or techniques segment the input document into an image layer and a text layer. The image layer includes the background and non-textual information, while the text layer includes the textual information with a color mask.

The text layer is segmented based on colors. For example, if text contents are having three colors including red, green, and blue, then red color text contents are combined and tagged as red color and grouped together as a text layer. Likewise, green and blue text layers are created. Accordingly, three tags and three different text layers are created based on colors. In an aspect, the grouping of the text contents is performed using known morphological methods or techniques.

The application of segmentation methods or techniques is followed by a processing step of determining whether a text group in the text layer has a color different than the color mask of the text layer. In case the text group has a different color than the color mask of the text layer, a processing step of ascertaining whether the color mask is above a threshold value. In other words, the processing step of ascertaining includes ascertaining whether the color mask of each of the text contents is having an intensity above a threshold value of the color tagged in that text layer.

As per implementation of the present subject matter, in case the color mask is ascertained above the threshold value, an average or a weighted average of the color mask is calculated. Based on the calculation, a new color as the color mask is identified and applied to the text group so as to modify the text layer. With the modification of the text layer based on the color tags of the text contents, not only improves text scan and text color quality, but may also provide an opportunity for file size reduction (i.e., efficient data compression), reduce artifacts, avoid color variation while printing the scanned image, and save toner. For example, if there are 60 pixels of one color and 40 pixels of a different color, then 40 pixels may be filled with the same color.

As per the conventional scheme, the modified text layer or foreground layer is compressed using any of binary compression schemes such as JBIG2, while the image layer or background layer is compressed using standard contone compression schemes such as JPEG.

After completion of the compression, the modified text layer and the image layer are integrated to generate the image data in the MRC file format. The image data in the MRC file format is then stored into a memory device.

The present subject matter may further optionally include additional steps, which are not meant to be limiting. For example, after the compression and storage, the image data may be optionally decompressed and output by an output device. The output device may be any type of device that is designed to output the image data. Examples of the output device may include, but not limited to, display, copy, print, or send the image data. Such output devices may further include a multifunctional device (MFD) or a printer.

### Exemplary Implementations

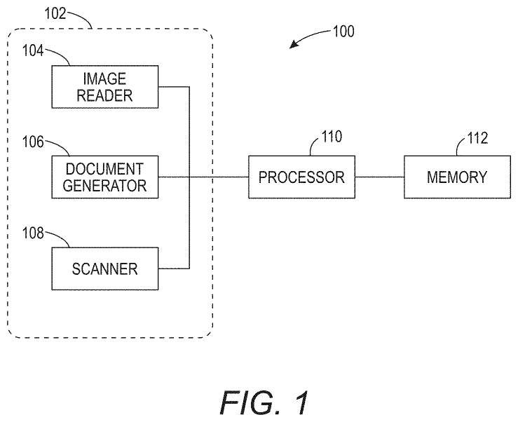

FIG. 1 illustrates an image processing system 100 as per implementation of the present subject matter. The image processing system 100 employs an image capturing device 102 to read or otherwise receive an input document or image, optionally, a full-color document or image. The image capturing device 102 may include one or more suitable input devices such as an electronically or otherwise stored image reader 104 which reads in the input document or image as pixels or digital image data, a computer image or document generator 106 which generates the input document or image as pixels or digital image data, a scanner 108 which optically scans images, printed text, handwriting or an object and converts it to a digital image data, or the like. Such digitized image data exists as a file on a computer network or a document management/processing network.

The image data of the input document is then processed by a processor 110 coupled to the image capturing device 102. The processor 110, amongst other capabilities, may be configured to fetch and execute computer-readable instructions stored in a memory 112. The processor 110 may be implemented as one or more microprocessors, microcomputers, microcontrollers, digital signal processors, central processing units, state machines, logic circuitries, and/or any devices that manipulate signals based on operational instructions. The functions of the various elements shown in the figure, including any functional blocks labeled as a processor(s), may be provided through the use of dedicated hardware as well as hardware capable of executing software in association with appropriate software.

When provided by the processor 110, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), non-volatile storage. Other hardware, conventional and/or custom, may also be included.

Returning to the present subject matter, the processor 110 carries out segmentation followed by an MRC compression on the image data. Once the segmentation and compression of the received image data is completed, the compressed image data is output by the processor 110. The image data is then electronically stored in the memory 112 or an otherwise appropriated storage device. Alternately, the image data is stored optically or magnetically on a disk or tape. In any event, the compressed document or image is readily accessed and/or transported over the network in the usual manner. Further, as mentioned above in the present disclosure, prior to rendering by an appropriate rendering engine or device, such as a printer, display monitor, digital copier, fax machine, and the like, the compressed image data is first decompressed or otherwise reconstructed in the usual manner.

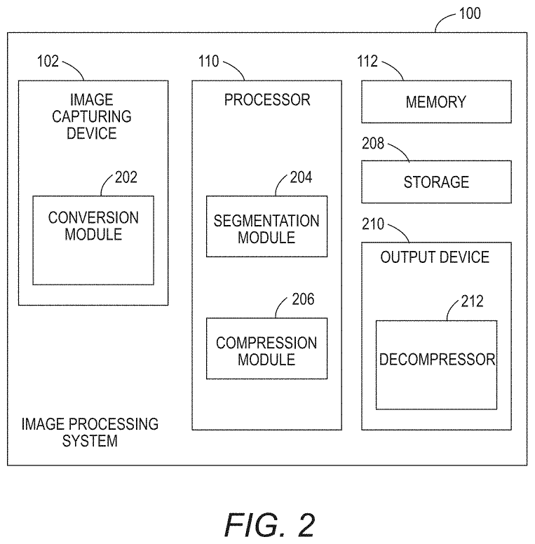

The image processing system 100 and the processes associated with the image processing system 100 are shown and described with reference to FIG. 2, in accordance with an implementation of the present disclosure. In FIG. 2, the image processing system 100 includes a number of devices for processing of image data. In an exemplary implementation, each of the devices shown in the image processing system 100 may also be considered as modules, and, therefore, the terms “device” and “module” are used interchangeably hereinafter. Further, the “devices” or “modules” illustrated in FIG. 2 are not meant to be limiting.

As per the implementation shown in FIG. 2, the capturing device 102 of the image processing system 100 is configured to receive image data as an input document. In an example, the image capturing device 102 may be an input device. The image capturing device 102 may be any type of device for receiving the image data. Examples of the image capturing device 102 may include, but not limited to, a scanning device, a facsimile device, a computing device, a storage device, and the like.

In an implementation, the image capturing device 102 may include a conversion module 202 for converting the received image data, such as converting gray scale image data from an input device color space, such as RGB (red, green, blue), to a device independent processing color space, such as YCC/YC_{B}C_{R} (where Y′ is the luma component and C_{B} and C_{R} are the blue-difference and red-difference chroma components) or LAB (where L for lightness and a and b for the color opponents green-red and blue-yellow) color space, where intensity and color information (i.e., luminance and chrominance) are separated. Generally, the types of color spaces for image data and the conversion of such color spaces are known in the art. The conversion module 202 may be a part of the image capturing device 102 or a separate device or module, without deviating from the scope of the present subject matter.

The received image data comprises a plurality of pixels. The plurality of pixels of the image data is processed by a segmentation module 204 of the processor 110 in order to separate or segment the image data signal (or input data) into different layers. The segmentation module 204 segments the image data for compression. In an implementation, the segmentation module 204 may be configured to segment and optionally tag the image data (e.g., each of its pixels) to identify the types of data represented before a compression scheme is determined and/or selected. For example, based on the tag information associated with the image data, the segmentation module 204 generally segments the image data into an image layer and a text layer. The image layer includes the background and non-textual information, while the text layer includes the textual information. Also, the text layer is generally segmented based on colors. For example, if text contents in three colors including red, green, and blue, then red color texts are combined and tagged as red color and grouped together as a text layer. Likewise, green and blue text layers are created.

The image layer and the text layer are then compressed using standard compression schemes and are integrated in accordance with MRC compression scheme using a compression module 206 of the processor 110.

After completion of the compression by the compression module 206, the image layer and the text layer are integrated and processed by the processor 110. The processor 110 may be coupled to a combination of image processing elements or modules (not shown in the Figures) which comprise software and hardware elements that may perform a number of operations on the image data received from the image capturing device 102 using a set of parameters. The set of parameters may be used to convert the integrated layers to a format desired as output (e.g., high quality) along with an image path. In an example, the integrated layers are converted to MRC file format. The elements may be a part of a computer system, device, or apparatus such as a photocopier, a printing device, or a multi-function device (MFD).

The MRC file format data is then provided by or stored by the processor 110 in the memory 112 or the storage 208. From the memory 112 or the storage 208, an output device 210 may be provided to output the image data. The output device 210 may be any type of device that is designed to output the image data. For example, the output device 210 may display, copy, print, or send the image data. Examples of the output device 210 may include, but not limited to, an MFD, printer, copier, scanner, facsimile device, display, a terminal, an image storage system, and CPU.

In an implementation, the output device 210 may decompress the image data and its information before output. For decompression, the image processing system 100 or the output device 210 may include a decompressor 212 to decompress the image data before sending the image data to a rendering engine of the output device 210. The decompressor 212 and the output device 210 may be the same module, or separate modules, without deviating from the scope of the present subject matter.

Furthermore, the image processing system 100 described with reference to FIG. 2 may implement a conventional compression scheme as well as a new compression scheme in accordance with the present subject matter disclosed herein, to improve the text representation quality of output of the image processing system 100.

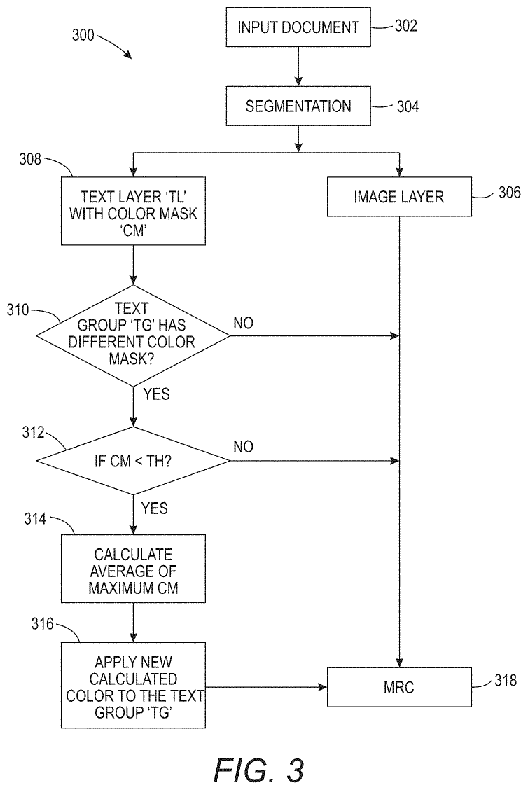

FIG. 3 illustrates a compression scheme 300 as per implementation of the present disclosure. As per the compression scheme 300, the image capturing device 102 of the image processing system 100 is configured to receive image data as a “scanned image” or an “input document” (Step 302). Thereafter, the plurality of pixels of the image data is processed by the segmentation module 204 of the processor 110 in order to separate or segment the image data signal (or input data) into different layers. The segmentation module 204 segments the image data for compression (Step 304). The segmentation module 204 generally segments the image data into the image layer (Step 306) and the text layer with a color mask (Step 308). The image layer includes the background and non-textual information, while the text layer includes the textual information. As mentioned earlier, the text layer is generally segmented based on colors. For example, if text contents in three colors including red, green, and blue, then red color texts are combined and tagged as red color and grouped together as a text layer. Likewise, green and blue text layers are created.

Once the text layer with a color mask is created, it is determined whether a text group in the text layer has a color different than the color mask information of the text layer (Step 310). In an example, a text group may be a chroma such a group of texts including, but not limited to, a word, a phrase, or the like. With this as the basis, it is determined whether the color of a character/alphabet/line is different from the maximum occurring color in the text group and within a limit of the chroma.

In case any character/alphabet/line of the text group is having a color different from the color mask, it is ascertained whether the color mask is above a threshold value (Step 312). In other words, it is ascertained whether the color mask of each of the contents of the text layer is having pixel intensity above a threshold value of the color tagged in that text layer. For instance, a text layer is having a color mask of red color, the pixel intensity of each of the contents in the text layer is compared with the pixel intensity of the color mask of red color.

As per implementation of the present subject matter, in case the color mask is ascertained above the threshold value, an average or a weighted average of the color mask is calculated (Step 314). Based on the calculation, a new color as the color mask is identified and applied to the text group so as to modify the text layer (Step 316). For instance, if the color of a character is different from the maximum occurring color in the text group and within a limit of chroma, then the color of the character is replaced with the maximum occurring color.

With the modification of the text layer based on the color tags of the text contents, not only improves text scan and text color quality, but may also provide an opportunity for file size reduction (i.e., efficient data compression), reduce artifacts, avoid color variation while printing the scanned image, and save toner.

Thereafter, as per the compression scheme 300 shown in FIG. 3, the image layer is compressed using standard contone compression schemes such as JPEG, while the text layer is compressed using any of the binary compression schemes such as JBIG2. Thereafter, the compressed text and image layers are integrated in accordance with MRC compression scheme to generate an MRC file format (Step 318).

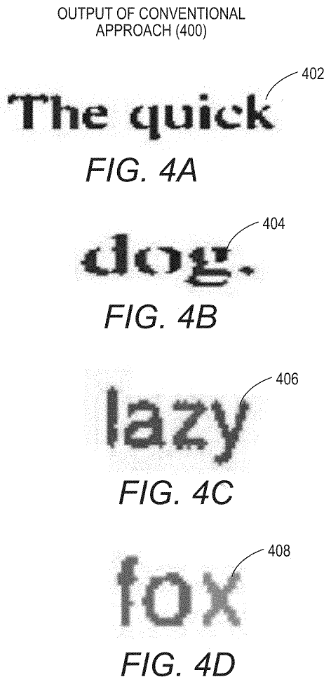

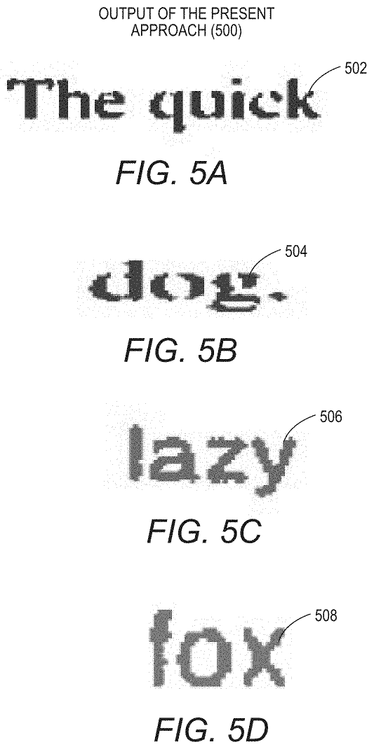

Thus, with the implementation of the present subject matter, the image data is output using the various approaches and implementations of the present subject matter with reduced or no compression artifacts, as can be seen from the comparison of output 400 (refer to FIGS. 4A, 4B, 4C, 4D) generated by conventional compression scheme, with output 500 (refer to FIGS. 5A, 5B, and 5C, 5D) of the proposed compression scheme 300 of the present disclosure discussed above in FIG. 3.

For example, in an output image 402 shown in FIG. 4A, the text group “The quick” has blue color except a character/alphabet “h” which is having violet color with the implementation of the conventional compression scheme. However, on the other hand, in an output image 502 shown in FIG. 5A, all the characters/alphabets of the text group “The quick” have blue color with the implementation of the present/new compression scheme 300. This improves the clarity and quality of the output image 502.

Similar to the comparison of the implementation of the conventional compression scheme and the present/new compression scheme 300 for the text group “The quick,” FIGS. 4B and 5B show comparison for the text group “dog” with reference numerals 404 and 504, where in the conventional compression scheme, the character/alphabet “o” has blue color in the text group “dog” having violet color. FIGS. 4C and 5C show comparison for the text group “lazy” with reference numerals 406 and 506, where in the conventional compression scheme, the character/alphabet “o” has blue color in the text group “dog” having violet color. FIGS. 4D and 5D show comparison for the text group “fox” with reference numerals 408 and 508, where in the conventional compression scheme, the character/alphabet “x” has light grey color in the text group “dog” having a grey color. From the comparative FIGS. 4A-4D and 5A-5D, output images 502, 504, 506, and 508 of the present disclosure provide clarity and quality of the output image.

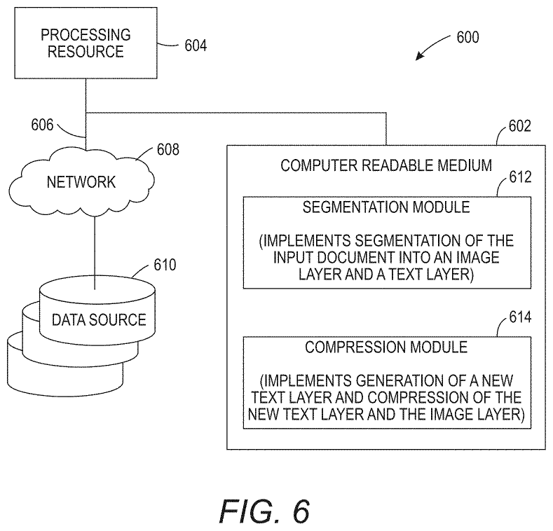

FIG. 6 illustrates an example network environment 600 using a non-transitory computer-readable medium 602 for performing the operation of the image processing system 100, according to an implementation of the present subject matter. The network environment 600 may be a public networking environment or a private networking environment. In one example, the network environment 600 includes a processing resource 604 communicatively coupled to the non-transitory computer readable medium 602 through a communication link 606.

For example, the processing resource 604 can be a processor, such as the control device of the image processing system 100. The non-transitory computer-readable medium 602 can be, for example, an internal memory device or an external memory device. In one example, the communication link 806 may be a direct communication link, such as one formed through a memory read/write interface. In another example, the communication link 606 may be an indirect communication link, such as one formed through a network interface. In such a case, the processing resource 604 can access the non-transitory computer readable medium 602 through a network 608. The network 608 may be a single network or a combination of multiple networks and may use a variety of communication protocols.

The processing resource 604 and the non-transitory computer readable medium 602 may also be communicatively coupled to data sources 810 over the network 608. The data sources 610 can include, for example, databases and computing devices. The data sources 610 may be used by the database administrators and other users to communicate with the processing resource 604.

In one example, the non-transitory computer-readable medium 602 can include a set of computer readable instructions, such as a segmentation module 612 and a compression module 614. The set of computer readable instructions referred to as instructions hereinafter, can be accessed by the processing resource 604 through the communication link 606 and subsequently executed to perform acts for network service insertion. In other words, during operation, the processing resource 604 can execute the segmentation module 612 and the compression module 614.

On execution by the processing resource 604, the segmentation module 612 can receive an image data including a plurality of pixels. The plurality of pixels of the image data is processed by the segmentation module 612 in order to separate or segment the image data signal (or image data) into different layers. In an implementation, the segmentation module 612 may be configured to segment and optionally tag the image data (e.g., each of its pixels) to identify the types of data represented before a compression scheme is determined and/or selected. For example, based on the tag information associated with the image data, the segmentation module 612 generally segments the image data into an image layer and a text layer with a color mask. The image layer includes the background and non-textual information, while the text layer includes the textual information. As mentioned earlier, the text layer is generally segmented based on colors. For example, if text contents in three colors including red, green, and blue, then red color texts are combined and tagged as red color and grouped together as a text layer. Likewise, green and blue text layers are created.

Further, as per the implementation of the present subject matter, the compression module 614 in association with the processing resource 604 determines whether a text group in the text layer has a color different than color mask information of the text layer. In an example, a text group may be a chroma such a group of texts including, but not limited to, a word, a phrase, or the like. With this as the basis, it is determined that the color of a character/alphabet/line is different from the maximum occurring color in the text group and within a limit of the chroma.

In case any character/alphabet/line of the text group is having a color different from the color mask information, it is ascertained whether the color mask is above a threshold value. In other words, it is ascertained whether the color mask of each of the contents of the text layer is having pixel intensity above a threshold value of the color tagged in that text layer. For instance, a text layer is having a color mask of red color, the pixel intensity of each of the contents in the text layer is compared with the pixel intensity of the color mask of red color.

As per implementation of the present subject matter, in case the color mask is ascertained above the threshold value, an average or a weighted average of the color mask is calculated. Based on the calculation, a new color as the color mask is identified and applied to the text group so as to modify the text layer. For instance, if the color of a character is different from the maximum occurring color in the text group and within a limit of chroma, then the color of the character is replaced with the maximum occurring color.

With the modification of the text layer based on the color tags of the text contents, not only improves text scan and text color quality, but may also provide an opportunity for file size reduction (i.e., efficient data compression), reduce artifacts, avoid color variation while printing the scanned image, and save toner. The modified text layer provides color uniformity in the MRC file.

Then, the modified text layer is compressed using binary compression schemes such as JBIG2 and the image layer is compressed using standard contone compression schemes such as JPEG. After completion of the compression, the modified text layer and the image layer are integrated to generate the image data in the MRC file format. The image data in the MRC file format is then stored into a memory device.

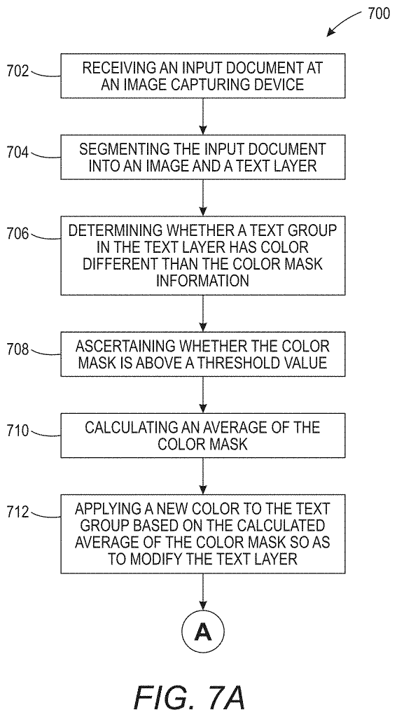

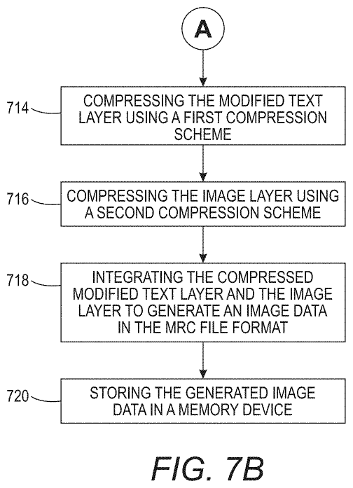

Method 700 is described in FIGS. 7A-7B for operating the image processing system 100, according to an implementation of the present subject matter. The order in which the method 700 is described is not intended to be construed as a limitation, and any number of the described method blocks can be combined in any appropriate order to carry out the method 700 or an alternative method. Additionally, individual blocks may be deleted from the method 700 without departing from the scope of the subject matter described herein.

The method 700 can be performed by programmed computing devices, for example, based on instructions retrieved from the non-transitory computer-readable medium or non-transitory computer-readable media. The computer-readable media can include machine-executable or computer-executable instructions to perform all or portions of the described method. The computer readable media may be, for example, digital memories, magnetic storage media, such as magnetic disks and magnetic tapes, hard drives, or optically readable data storage media.

Referring to FIGS. 7A and 7B, the method 700 may be performed by a processing device, such as the processor 110 of the image processing system 100.

At block 702, the image processing system 100 receives an input document having image data comprising a plurality of pixels. The image data may be received as the input document by, for example, the image capturing device 102, or retrieved from the storage 208 or the memory 112. In an example, the image capturing device 102 may be an input device. The image capturing device may be any type of device for receiving input image data. An example of the image capturing device may include, but not limited to, a scanning device, a facsimile device, a computing device, a storage device, and the like.

At block 704, once the input document is received, the input document is processed to determine the different types of data represented by the plurality of pixels of the image data using existing segmentation techniques. For example, the image data may include pixels representing, but not limited to, text, edge, background, and pictorial (non-text area) information. As per the present subject matter, any number of segmentation methods may be implemented to segment the input data having the image data into an image layer and a text layer with a color mask information. The image layer includes the background and non-textual information, while the text layer includes the textual information. As mentioned earlier, the text layer is generally segmented based on colors. For example, if text contents in three colors including red, green, and blue, then red color texts are combined and tagged as red color and grouped together as a text layer. Likewise, green and blue text layers are created.

At block 706, the application of segmentation methods or techniques is followed by a processing step of determining whether a text group in the text layer has a color different than the color mask information of the text layer. In an example, a text group may be a chroma such a group of texts including, but not limited to, a word, a phrase, or the like. With this as the basis, it is determined whether the color of a character/alphabet/line is different from the maximum occurring color in the text group and within a limit of the chroma.

At block 708, in case any character/alphabet/line of the text group is having a color different from the color mask information, it is ascertained whether the color mask is above a threshold value. In other words, it is ascertained whether the color mask of each of the contents of the text layer is having pixel intensity above a threshold value of the color tagged in that text layer. For instance, a text layer is having a color mask of red color, then pixel intensity of each of the contents in the text layer is compared with the pixel intensity of the color mask of red color.

At block 710, in case the color mask is ascertained above the threshold value, an average or a weighted average of the color mask is calculated.

At block 712, based on the calculation, a new color as the color mask is identified and applied to the text group to modify the text layer. For instance, if the color of a character is different from the maximum occurring color in the text group and within a limit of chroma, then the color of the character is replaced with the maximum occurring color.

With the modification of the text layer based on the color tags of the text contents, not only improves text scan and text color quality, but may also provide an opportunity for file size reduction (i.e., efficient data compression), reduce artifacts, avoid color variation while printing the scanned image, and save toner.

At block 714, the modified text layer is compressed using binary compression schemes such as JBIG2.

At block 716, the image layer is compressed using standard contone compression schemes such as JPEG.

At block 718, after completion of the compression, the modified text layer and the image layer are integrated to generate the image data in the MRC file format. The processor 110 may be coupled to a combination of image processing elements or modules (not shown in the Figures) which comprise software and hardware elements that may perform a number of operations on the image data received from the image capturing device 102 using a set of parameters. The set of parameters may be used to convert the integrated layers to a format desired as output (e.g., high quality) along an image path. In an example, the integrated layers are converted to MRC file format.

At block 720, the image data in the MRC file format is then stored by the processor 110 in the memory 112 or the storage 208. From the memory 112 or the storage 208, an output device 210 may be provided to output the image data. The output device 210 may be any type of device that is designed to output the image data. For example, the output device 210 may display, copy, print, or send the image data. Examples of the output device 210 may include, but not limited to, an MFD, a printer, a copier, a scanner, a facsimile device, display, a terminal, an image storage system, and a CPU.

At the time of extraction, the method includes: extracting the image data in the MRC file format from the memory device to retrieve the compressed text layer and the compressed image layer; decompressing the image data present in the MRC file format; and transmitting the decompressed the image data present in the MRC file format to an output device. The MRC file format is extracted when a user wishes to view the file, copy the file, print the file, send the file, or the like.

The method may be implemented in the form of a non-transitory computer-readable medium including instructions executable by a processing resource. The processing resource performs the method blocks 702-720 and other method blocks for implementing the current disclosure.

Further, the present subject matter is disclosed herein with reference to an image processing architecture; however, the subject matter is equally applicable to printing systems implemented in multi-functional devices, such as printers, copiers, and the like, which are in direct communication with the user devices.

The methods and systems of the present disclosure reduce file size and further improve image quality by removing compression artifacts, when documents with color backgrounds are scanned. The methods and systems further avoid color variation while printing the scanned file or otherwise. For example, each character of a word has a consistent and uniform color. The methods and systems further save toner.

The present disclosure may be implemented while scanning an input document. The “MRC” format is a file format including content in the form of an image layer and text layer and on such popular format is PDF, without any limitation. An image processing system receives an input document for scanning and processes the document to generate the digital document, in an MRC file format. The “input document” may be in physical form, such as printed on paper and may include content such as text, image, or a combination thereof. The content may be referred to as image data or image data may be generated upon scanning. The term “digital document” refers to a document in a virtual or software form (embodied in a software file). The virtual form can also be referred to as digital form, electronic version or the like. The digital document is in a PDF form. The PDF may be generated in an MRC file format. In the MRC file format, image content and text content are stored separately as separate layers, i.e., image content is stored as an image layer, while the text content is stored as a text layer.

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details.

The present disclosure addresses an artifact of the Mixed Raster Content (MRC) process that leave different letters of a word colored differently. To this end, the methods and systems perform word level segmentation, analyze each of the letters in the word to ensure they are colorized identically using the average estimated color. The methods and systems further provide consistency in the appearance of the scanned text. The methods and systems further improve scan quality and color and file size. The methods and systems avoid color variation while printing the scanned file. The methods and systems further save toner. The methods and systems facilitate uniform and consistent color for every character of the text group.

Note that throughout the disclosure, numerous references may be made regarding servers, services, schemes, engines, modules, or other systems formed from computing devices. It should be appreciated that the use of such terms are deemed to represent one or more computing devices having at least one processor configured to or programmed to execute software instructions stored on a computer readable tangible, non-transitory medium or also referred to as a processor-readable medium. For example, a server can include one or more computers operating as a web server, database server, or other type of computer server in a manner to fulfill described roles, responsibilities, or functions. Within the context of this document, the disclosed devices or systems are also deemed to comprise computing devices having a processor and a non-transitory memory storing instructions executable by the processor that cause the device to control, manage, or otherwise manipulate the features of the devices or systems.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “processing,” or “determining,” or “presenting,” or “segmenting,” or “generating,” “compressing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

Further, the terminology used herein is for the purpose of describing particular embodiments only and is not intended to be limiting of the disclosure. It will be appreciated that several of the above-disclosed and other features and functions, or alternatives thereof, may be combined into other systems or applications. Various presently unforeseen or unanticipated alternatives, modifications, variations, or improvements therein may subsequently be made by those skilled in the art without departing from the scope of the present disclosure as encompassed by the following claims.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method for generating a mixed raster content (MRC) format file, the method comprising:
receiving an input document at an image capturing device;
segmenting the input document into an image layer and a text layer with a color mask information;
determining whether a text group in the text layer has color different than the color mask information;
upon affirmative determination, ascertaining whether the color mask is above a threshold value;
upon affirmative ascertainment, calculating an average of the color mask;
applying a new color to the text group based on the calculated average of the color mask so as to modify the text layer;
compressing the modified text layer using a first compression scheme;
compressing the image layer using a second compression scheme;
integrating the compressed the modified text layer and the image layer to generate an image data in the MRC file format such that the modified text layer provides color uniformity in the MRC file; and
storing the generated image data in a memory device.

2. The method as claimed in claim 1, wherein the first compression scheme is a binary compression scheme.

3. The method as claimed in claim 2, wherein the binary compression scheme is JBIG2 compression.

4. The method as claimed in claim 1, wherein the second compression scheme is a standard contone compression scheme.

5. The method as claimed in claim 4, wherein the standard contone compression scheme comprises JPEG compression.

6. The method as claimed in claim 1, wherein the segmenting of the input document into the text layer with a color mask information is performed based on colors.

7. The method as claimed in claim 6, wherein the segmenting of the input document into the text layer comprising:
identifying color of the texts in the input document;
combining texts having same color;
assigning a tag to the texts having same color; and
generating a text layer with color mask based on the tag assigned to the texts having same color.

8. The method as claimed in claim 7, wherein the segmenting of the input document into the text layer comprising creating multiple text layers each having texts of different respective colors.

9. The method as claimed in claim 1, further comprising:
extracting the MRC file format from the memory device to retrieve the compressed modified text layer and the compressed image layer;
decompressing the MRC file format; and
transmitting the decompressed MRC file format to an output device.

10. An image processing system for generating a mixed raster content (MRC) format file, the image processing system comprising:
an input device for receiving an input document;
a processor, coupled to the input device;
a segmentation module, coupled to the processor, to segment the input document into an image layer and a text layer with a color mask information; and
a compression module, coupled to the processor, to:
determine whether a text group in the text layer has color different than the color mask information;
upon affirmative determination, ascertain whether the color mask is above a threshold value;
upon affirmative ascertainment, calculate an average of the color mask;
apply a new color to the text group based on the calculated average of the color mask so as to modify the text layer;
compress the modified text layer using a first compression scheme;
compress the image layer using a second compression scheme;
integrate the compressed the modified text layer and the image layer to generate an image data in the MRC file format; and
store the generated image data in a memory device.

11. The image processing system as claimed in claim 10, wherein the first compression scheme is a binary compression scheme.

12. The image processing system as claimed in claim 11, wherein the binary compression scheme is JBIG2 compression.

13. The image processing system as claimed in claim 10, wherein the second compression scheme is a standard contone compression scheme.

14. The image processing system as claimed in claim 13, wherein the standard contone compression scheme comprises JPEG compression.

15. The image processing system as claimed in claim 10, wherein the compression module is to segment the input document into the text layer with a color mask is performed based on colors.

16. The image processing system as claimed in claim 15, wherein the compression module is to segment the input document into the text layer, by:
identifying color of the texts in the input document;
combining texts having same color;
assigning a tag to the texts having same color; and
generating a text layer with color mask based on the tag assigned to the texts having same color.

17. The image processing system as claimed in claim 16, wherein the segmenting of the input document into the text layer comprising creating multiple text layers each having texts of different respective colors.

18. The image processing system as claimed in claim 10, wherein the process is to:
extract the image data in the MRC file format from the memory device to retrieve the compressed modified text layer and the compressed image layer;
decompressing the image data present in the MRC file format; and
transmitting the decompressed the image data present in the MRC file format to an output device.

19. A non-transitory computer-readable medium comprising instructions executable by a processing resource to:
receive an input document at an image capturing device;
segment the input document into an image layer and a text layer with a color mask information;
determine whether a text group in the text layer has color different than the color mask information;
upon affirmative determination, ascertain whether the color mask is above a threshold value;
upon affirmative ascertainment, calculate an average of the color mask;
applying a new color to the text group based on the calculated average of the color mask so as to modify the text layer;
compress the modified text layer using a first compression scheme;
compress the image layer using a second compression scheme;
integrate the compressed the modified text layer and the image layer to generate an image data in the MRC file format; and
store the generated image data in a memory device.

20. The non-transitory computer-readable medium as claimed in claim 19, wherein the first compression scheme is a binary compression scheme.

21. The non-transitory computer-readable medium as claimed in claim 20, wherein the binary compression scheme is JBIG2 compression.

22. The non-transitory computer-readable medium as claimed in claim 19, wherein the second compression scheme is a standard contone compression scheme.

23. The non-transitory computer-readable medium as claimed in claim 22, wherein the standard contone compression scheme comprises JPEG compression.

24. The non-transitory computer-readable medium as claimed in claim 21, comprising instructions executable by the processing resource to segment the input document into the text layer with a color mask is performed based on colors.

25. The non-transitory computer-readable medium as claimed in claim 24, comprising instructions executable by the processing resource to segmenting the input document into the text layer, by:
identifying color of the texts in the input document;
combining texts having same color;
assigning a tag to the texts having same color; and
generating a text layer with color mask based on the tag assigned to the texts having same color.

26. The non-transitory computer-readable medium as claimed in claim 25, comprising instructions executable by the processing resource to segment the input document into the text layer comprising creating multiple text layers each having texts of different respective colors.

27. The non-transitory computer-readable medium of claim 21 comprising instructions executable by the processing resource to:
extract the image data in the MRC file format from the memory device to retrieve the compressed text layer and the compressed image layer;
decompress the image data present in the MRC file format; and
transmit the decompressed the image data present in the MRC file format to an output device.
